(19) United States
(12) Patent Application Publication
(10) Pub. No.: US 2024/0208313 A1
(43) Pub. Date: Jun. 27, 2024

(54) LOWER BEAUTY COVER

(71) Applicant: Honda Motor Co., Ltd., Tokyo (JP)

(72) Inventors: Hiroshi SHINGU, Walled Lake, MI (US); Yuichiro SAIKI, Sakura-shi (JP); Takahiro OHNO, Wako-shi (JP); Masatoshi ADACHI, Haga gun (JP)

(21) Appl. No.: 18/086,360

(22) Filed: Dec. 21, 2022

(51) Int. Cl. B60J 11/06; B60J 5/06

(52) U.S. Cl. CPC B60J 11/06; B60J 5/06; B60R 13/04

(57) ABSTRACT

A cover assembly, for covering a visible surface of a side sill pocket for a lower sliding door rail of a vehicle, includes a cover and a mechanical fastener. The cover has a shape corresponding to a shape of the visible surface of the side sill pocket. The mechanical fastener is arranged on a bottom surface of the cover, and is used to reversibly connect the cover to the visible surface of the side sill pocket, thus covering at least a portion of the visible surface so as to hide the covered portion from view. The cover provides a different characteristic than the visible surface provides, and can be selectively removed for replacement, or for cleaning of the cover and/or surface of contamination.

### BACKGROUND

Sliding doors are often mounted to a side of a vehicle via a roller assembly and a roller track/rail, which rail is arranged in a pocket in a side sill of the vehicle. The pocket has an opening through which the roller is inserted to engage the rail. A surface of the pocket is visible through this opening, and the surface may not be aesthetically pleasing because it may be bare metal or painted metal, and may not match the decor of the other parts of the vehicle. Dirt and other contamination may also enter through this opening and into the pocket, and settle on the visible surface, thus further decreasing the aesthetics of the visible surface.

### BRIEF DESCRIPTION

According to one aspect, a cover assembly is configured to cover a visible surface of a side sill pocket for a lower sliding door rail of a vehicle. The cover assembly includes a cover and a mechanical fastener. The cover has a top surface and a bottom surface opposite from the top surface. The cover has a shape corresponding to a shape of the visible surface of the side sill pocket. The mechanical fastener is arranged on the bottom surface of the cover for reversibly connecting the cover to the visible surface of the side sill pocket.

According to another aspect, a vehicle includes a cover assembly, a sliding side door, a side sill pocket for the sliding door, and a lower sliding door rail arranged in the side sill pocket. The side sill pocket includes a surface that, if not covered by a cover of the cover assembly, is visible when the sliding side door is in an open position. The cover assembly includes the cover and a mechanical fastener. The cover has a top surface and a bottom surface opposite from the top surface. The cover has a shape corresponding to a shape of the surface of the side sill pocket. The mechanical fastener is arranged on the bottom surface of the cover. The cover is reversibly connected via the mechanical fastener to the surface of the side sill pocket and covers the surface of the side sill pocket to make a covered portion of the surface of the side sill pocket not visible when the sliding side door is in the open position.

According to another aspect, a method of covering a surface of a side sill pocket of a vehicle includes providing a cover assembly. The cover assembly includes a cover including a top surface and a bottom surface opposite from the top surface, the cover having a shape corresponding to a shape of the surface of the side sill pocket; and a mechanical fastener arranged on the bottom surface of the cover. The method includes reversibly connecting, via the mechanical fastener, the cover to the surface of the side sill pocket of the vehicle.

### BRIEF DESCRIPTION OF THE DRAWINGS

FIG. 1 is a side view of a vehicle with sliding side doors according to the present subject matter.

FIG. 2 is an exploded view of a side sill pocket and a rail according to the present subject matter.

FIG. 3 is a perspective view of a rear portion of the side sill pocket and the rail of FIG. 2 in a connected state.

FIG. 4 is a perspective view of a front portion of the side sill pocket and the rail of FIG. 2 in a connected state.

FIG. 5 is a perspective view of a cover assembly according to the present subject matter.

FIG. 6 is a cross section view of a cover assembly according to the present subject matter.

FIG. 7 is a perspective view of a cover assembly reversibly connected to a surface of the side sill pocket according to the present subject matter.

FIG. 8 is a perspective view, through open sliding doors, of a cover assembly reversibly connected a surface of the side sill pocket according to the present subject matter.

### DETAILED DESCRIPTION

The present subject matter provides a cover assembly for a vehicle for covering over a surface in a side sill pocket of the vehicle so as to provide a changed or enhanced feature to the pocket. The cover assembly includes a cover and a mechanical fastener arranged on a bottom surface of the cover and used to reversibly connect the cover to the visible surface of the side sill pocket, thus covering at least a portion of the visible surface so as to hide the covered portion from view. The cover may provide a different characteristic than that provided by the visible surface, and can be selectively removed for replacement, or for cleaning of the cover and/or surface of contamination

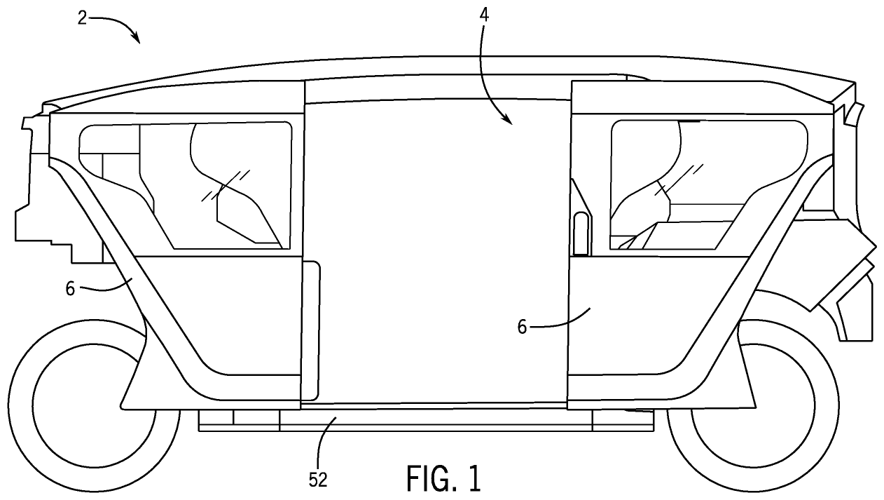

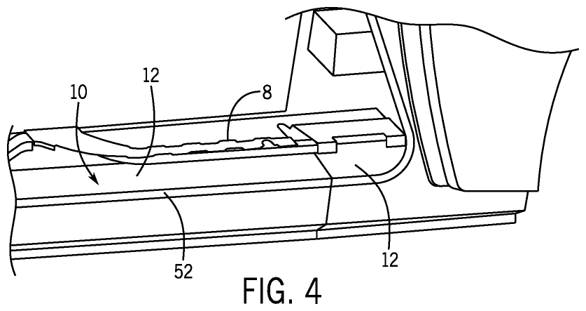

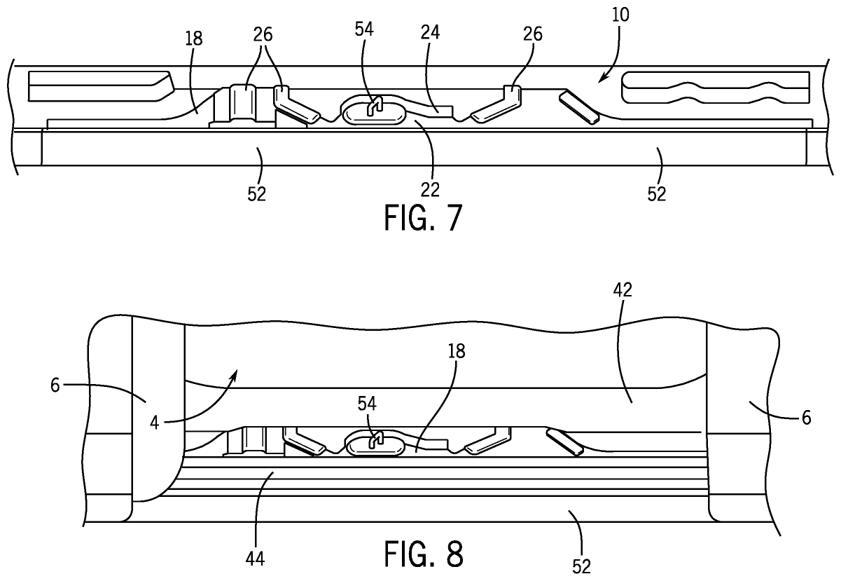

Referring to FIGS. 1-8, a vehicle 2 includes a side door opening 4 with a side sill 52, which is closed by one or more sliding side doors 6. The vehicle 2 may include one sliding side door 6, or two or more sliding side doors 6. The sliding door(s) 6 is slidably mounted via roller(s) (not shown) that roll on one or more sliding door rails/tracks 8, by which the door(s) 6 moves between an open position, uncovering the opening 4, and a closed position, covering the opening 4. The opening 4 may be used for transmitting people or goods in or out of an interior compartment of the vehicle 2.

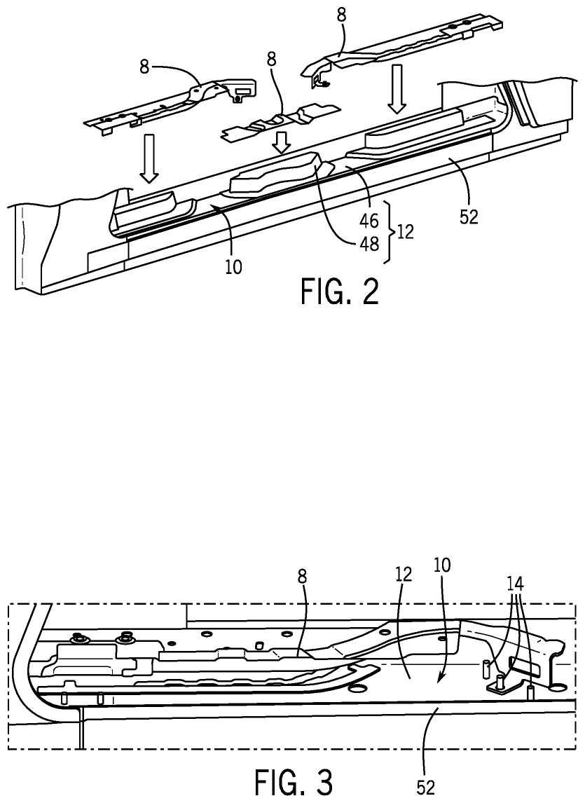

A lower sliding door rail 8, which guides the roller(s) of the door 6, is arranged in a pocket 10 in the side sill 52. The rail 8 may include one or more pieces. As show in FIG. 2, the rail 8 includes three pieces, which are attached to a top of the pocket 10. The rail 8 can include more or less than three pieces. The side sill pocket 10 includes a surface 12, e.g. a bottom surface, a vertical surface, other surfaces, or combinations thereof, that may be visible through an opening in the side sill pocket 10 when the door 6 is in the open position. This surface 12 may be, but is not required to be, part of a frame or other component of the vehicle 2 that is present in the “body in white” phase, and/or may be otherwise unadorned and/or display a raw metal or a plain painted metal. This surface 12 may include one or more projections 14 sticking up from the surface 12, e.g. fasteners sticking through the surface 12 or up from the surface 12, which may be used to connect the pocket 10 to other components of the vehicle 2 or vice versa.

The visible surface 12 may present an undesirable aesthetic as it may be part of the body in white phase and/or may not be coordinated with, match, or provide a similar appearance as other visible surfaces of the vehicle. A cover assembly 16 may therefore be used to cover over this surface 12. The cover assembly 16 includes a cover 18, and a mechanical fastener 20 that reversibly connects the cover to the surface 12. The cover assembly 16 is arranged in the pocket 10 to cover the visible surface 12 so a to make a covered portion of the surface 12 not visible, e.g. no longer visible through the opening in the pocket 10.

The cover 18 may be a one-piece construction or a multi-piece construction. The cover 18 is used to cover over a portion of the surface 12 and may provide a visual aesthetic different than that provided by the visible surface 12. The cover 18 may be applied to the pocket 10 to provide the surface 12 with a different or enhanced color, texture, pattern, haptics, smell, durability, resistance to environmental exposure or contaminants, etc., and combinations thereof than that provided by the surface 12 without the cover 18. The cover 18 may match the visual aesthetics, e.g. color, of a trim piece, e.g. a flooring panel 42 or weather stripping 44, that is adjacent to the pocket 10. The cover 18 may act as a barrier to dust, dirt, or other contamination that may collect in the pocket 10.

The cover 18 may have one or more physical dimensions or characteristics, e.g. a shape, size, thickness, contour, etc., corresponding to the physical dimensions or characteristics of the pocket 10, of the surface 12, and/or of portions thereof. The cover 18 may be produced, e.g. by molding, vacuum forming, casting, additive manufacturing, etc. The cover 18 may be formed so as to correspond with the physical dimensions of the pocket 10 or surface 12, e.g. to fit into the pocket 10 and provide a close fit with the surface 12.

The cover 18 includes a sheet 22, and optionally a wall 24 extending up from an edge of the sheet 22. The sheet 22 and the wall 24 may be arranged at an angle with respect to each other, e.g. at a 90° angle or other angles between 45°-135°. The sheet 22 may cover a bottom surface 46 of the pocket 10, while the wall 24 may cover an upright surface 48 (e.g. vertical surface) of the pocket 10. The visible surface 12 may include portions of the bottom surface 46 and/or the upright surface 48 of the pocket 10.

The sheet 22 may include a bulge 26 extending upwards from the top surface 28 of the cover 18 and defining an indent at the bottom surface 30 of the cover 18. The bulge 26 may be configured, e.g. arranged, sized, shaped, etc., so as to accommodate the projection 14 underneath it in the indent, and thus cover the projection 14. The projection 14 may thus be covered by the sheet 22, under the bulge 26 and within the indent, and may not impact a shape of the sheet 22 or poke through the sheet 22. The cover 18 may include apertures 50 through which a projection 14 sticks through the cover 18 from the bottom surface 30 to the top surface 28. Such a projection 14 may be a latch anchor 54 for securing the door 6 in a closed position.

The cover 18 may be made of a cover material that maintains a shape of the cover 18, yet is flexible to allow the cover 18 to bend. The cover material is not particularly limited, and may be similar to a weather stripping material used to seal vehicle doors, and may include a polymer such as EPDM rubber, a thermoplastic elastomer (TPE), a TPE mix of plastic and rubber, a thermoplastic olefin (TPO) polymer, a TPO polymer/filler blend, or other polymer-containing materials. The cover material may include silicone, foam, rubber, or vinyl. The cover 18 may be formed by vacuum forming the cover material to produce a one-piece construction.

The cover 18 is reversibly connected to the surface 12 by the mechanical fastener 20, and thus may be selectively connected to or disconnected from the surface 12. The cover 18 may thus be attached and subsequently removed from the pocket 10 and from covering the surface 12, which may allow for replacement of the cover 18, cleaning of the cover 18 and/or the pocket 10, or for other purposes.

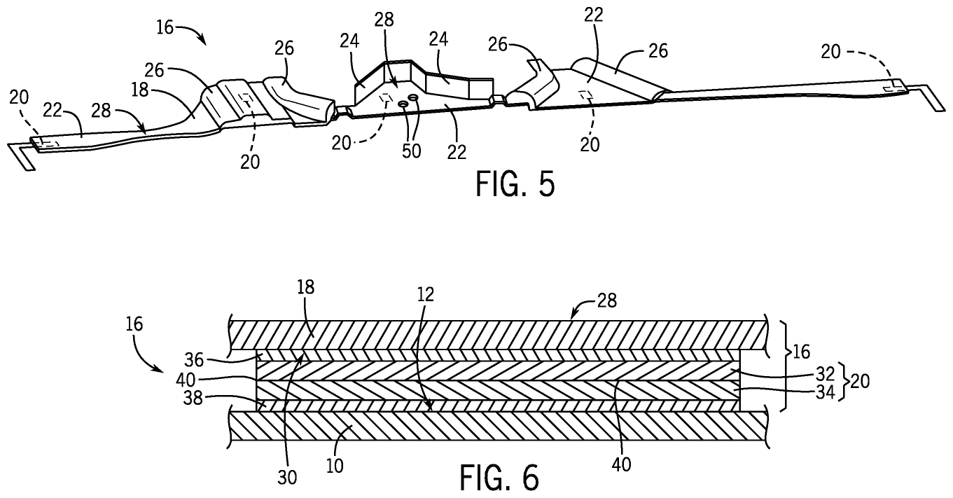

The mechanical fastener 20 may include hook and loop fasteners or other types of mechanical fasteners. The mechanical fastener 20 may include at least two strips of hook and loop fasteners 20 connected at different locations on the bottom surface 30 of the cover 18. As shown in FIG. 5, the cover assembly 16 includes four separate strips of hook and loop fasteners 20 connected at different locations on the bottom surface 30 of the cover 18. More or less strips of hook and loop fasteners 20 may be connected on the bottom surface 30 of the cover 18.

A first half 32 of the hook and loop fasteners 20, e.g. one of the hook fasteners or the loop fasteners, is attached to the bottom surface 30 of the cover 18 by a first adhesive 36 (e.g. a first double-sided adhesive tape) arranged between the hook and loop fasteners 20 and the bottom surface 30 of the cover 18. A second half 34 of the hook and loop fasteners 20, e.g. the other of the hook fasteners or the loop fasteners, is attached to the first half 32 of the hook and loop fasteners 20 by interaction at the interface 40 between the hooks and loops of the two halves 32, 34 of the hook and loop fasteners 20. The second half 34 of the hook and loop fasteners 20 may have a second adhesive 38 (e.g. a second double-sided adhesive tape) arranged on a side of the hook and loop fasteners 20 opposite from the cover 18 and opposite from the first adhesive 36 as shown in FIG. 6. The first and second adhesives 36, 38 may include a permanent adhesive for permanently adhering to a surface with which the adhesive comes in contact. The second adhesive 38 may have an exposed surface that is covered by a release liner, which may be removed prior to contacting the second adhesive 38 to the surface 12.

The cover 18 may be reversibly connected to the surface 12 via the mechanical fastener 20 by inserting the cover assembly 16 into the pocket 10 and contacting the second adhesive 38 to the surface 12 of the pocket 10. This results in the second half 34 of the hook and loop fasteners 20 being adhered to the surface 12 and thus connecting the cover 18 to the surface 12.

The cover 18 may be reversibly connected to the surface 12 by first connecting the second half 34 of the hook and loop fasteners 20 to the surface 12 via the second adhesive 38, and thereafter connecting the first half 32 of the hook and loop fasteners 20, which is connected to the cover 18 by the first adhesive 36, to the second half 34 of the hook and loop fasteners 20.

This reversible connection between the cover 18 and the surface 12 may be broken and reestablished. This connection may be broken by pulling the cover 18 away from the surface 12, which also results in the first double-sided adhesive tape 36, and the first half 32 of the hook and loop fasteners 20 being pulled away from the surface 12 along with the cover 18. Such pulling breaks the connection at the interface 40 between the first and second halves 32, 34 of the hook and loop fasteners 20, and allows the cover 18 to be removed from the surface 12, but leaves the second half 34 of the hook and loop fasteners 20 still attached to the surface 12 via the second double-sided adhesive tape 38. The second half 34 of the hook and loop fasteners 20 remains anchored on the surface 12, which allows for the cover 18, or a new cover 18, to be (re)attached to the surface 12 by (re)connecting the first half 32 of the hook and loop fasteners 20 to the second half 34 of the hook and loop fasteners 20, which are still connected to the surface 12.

A method of using the cover assembly 16 may include a method of making a vehicle 2 including the cover assembly 16. The method may include reversibly connecting, via the mechanical fastener 20, the cover 18 to the visible surface 12 of the side sill pocket 10 for the lower sliding door rail 8 of the vehicle 2. This reversible connection may be made at any time including during production of the vehicle 2 or after production of the vehicle 2. The reversible connection may be made between an original cover 18 or a replacement cover 18, which replaces an original cover 18 that has previously been removed from the side sill pocket 10.

The method may include removing the cover 18 from covering the surface 12. This may be done by removing the cover 18 from the pocket 10 and may be done by breaking or disconnecting the reversible connection formed by the mechanical fastener 20 between the cover 18 and the surface 12. Breaking or disconnecting the reversible connection may include breaking the interaction at the interface 40 between the hooks and loops of the two halves 32, 34 of the hook and loop fasteners 20.

The method may include cleaning the cover 18 after it has been removed from the pocket 10. The method may include inserting a new cover 18 or again arranging the original cover 18, in the pocket 10 by (again) establishing a (the) reversible connection between the cover 18 and the surface 12 via the mechanical fastener 20. This may include contacting the first half 32 of the hook and loop fasteners 20 with the second half 34 of the hook and loop fasteners 20.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A cover assembly for covering a visible surface of a side sill pocket for a lower sliding door rail of a vehicle, the cover assembly comprising:
a cover including a top surface and a bottom surface opposite from the top surface, the cover having a shape corresponding to a shape of the visible surface of the side sill pocket; and
a mechanical fastener arranged on the bottom surface of the cover for reversibly connecting the cover to the visible surface of the side sill pocket.

2. The cover assembly of claim 1, further comprising an adhesive arranged between the mechanical fastener and the cover, the adhesive connecting the mechanical fastener to the bottom surface of the cover.

3. The cover assembly of claim 2, wherein the adhesive is a double-sided adhesive tape.

4. The cover assembly of claim 2, wherein the mechanical fastener includes hook and loop fasteners.

5. The cover assembly of claim 4, further comprising a second adhesive arranged on a side of the hook and loop fasteners opposite from the cover.

6. The cover assembly of claim 5, wherein the second adhesive is a double-sided adhesive tape.

7. The cover assembly of claim 1, wherein the cover comprises a polymer.

8. The cover assembly of claim 7, wherein the polymer comprises a thermoplastic elastomer.

9. The cover assembly of claim 1, wherein the cover includes a bulge for accommodating thereunder a projection on the visible surface of the side sill pocket.

10. The cover assembly of claim 1, wherein the mechanical fastener includes at least two strips of hook and loop fasteners connected at different locations on the bottom surface of the cover.

11. The cover assembly of claim 1, wherein the cover comprises a sheet and a wall extending up from an edge of the sheet, the wall and the sheet being of a one-piece construction.

12. A vehicle including:
a cover assembly comprising a cover including a top surface and a bottom surface opposite from the top surface, and a mechanical fastener arranged on the bottom surface of the cover,
a sliding side door,
a side sill pocket for the sliding side door, the side sill pocket including a surface that, if not covered by the cover of the cover assembly, is visible when the sliding side door is in an open position, and
a lower sliding door rail for the sliding side door, the rail being arranged in the side sill pocket;
wherein the cover is reversibly connected via the mechanical fastener to the surface of the side sill pocket and covers the surface of the side sill pocket to make a covered portion of the surface of the side sill pocket not visible when the sliding side door is in the open position;
wherein the cover has a shape corresponding to a shape of the surface of the side sill pocket.

13. The vehicle of claim 12, wherein the cover assembly further comprises double-sided adhesive tape arranged between the mechanical fastener and the cover, the double-sided adhesive tape connecting the mechanical fastener to the bottom surface of the cover.

14. The vehicle of claim 13, wherein the mechanical fastener includes hook and loop fasteners.

15. The vehicle of claim 14, further comprising a second double-sided adhesive tape arranged on a side of the hook and loop fasteners opposite from the cover and connecting the hook and loop fasteners to the surface of the side sill pocket.

16. The vehicle of claim 12, wherein the cover comprises a thermoplastic elastomer.

17. The vehicle of claim 16, wherein the cover includes a bulge for accommodating thereunder a projection on the surface of the side sill pocket.

18. The vehicle of claim 12, wherein the mechanical fastener includes at least two strips of hook and loop fasteners connected at different locations on the bottom surface of the cover.

19. The vehicle of claim 12, wherein the cover comprises a sheet and a wall extending up from an edge of the sheet, the wall and the sheet being of a one-piece construction.

20. A method of covering a surface of a side sill pocket of a vehicle, the method including:
providing a cover assembly comprising:
a cover including a top surface and a bottom surface opposite from the top surface, the cover having a shape corresponding to a shape of the surface of the side sill pocket, and
a mechanical fastener arranged on the bottom surface of the cover; and
reversibly connecting, via the mechanical fastener, the cover to the surface of the side sill pocket of the vehicle.
